(19) United States
(12) Patent Application Publication
(10) Pub. No.: US 2013/0054274 A1
(43) Pub. Date: Feb. 28, 2013

(54) VISION INSURANCE INFORMATION SEARCH FACILITATION

(71) Applicant: VIPUL KATYAL, WESTON, FL (US)

(72) Inventor: VIPUL KATYAL, WESTON, FL (US)

(21) Appl. No.: 13/216,678

(22) Filed: Aug. 24, 2011

(51) Int. Cl. G06Q 40/00; G06F 17/30

(52) U.S. Cl. 705/4; 707/769; 707/E17.014

(57) ABSTRACT

Demographic information can be manually input into fields of a user interface. The demographic information can be for a patient of an eye care provider. One or more likely eye care insurers of the patient can be automatically determined from the demographic information. The eye care insurers that are accepted and that the patient is covered under can be unknown initially. A set of insurer maintained data stores corresponding to the set of one or more likely eye care insurers of the patient can be automatically determined. The set of insurer maintained data stores can be automatically searched for insurance information specific to individuals matching the demographic information. Results of the searching can be provided via the user interface, which identifies at least one eye care insurer of the patient and which provides an insurance number specific to an insurance policy of the patient.

### BACKGROUND

The present invention relates to the field of eye care and vision insurance and, more specifically, to identifying one or more individuals' vision insurance information by automatically searching a set of insurance data stores using patient demographic information.

Individuals often take advantage of vision products and services offered by eye care providers who are at a minimum partially compensated for their services by insurance policies carried by an individual receiving the service. One stipulation of such services is that individuals must present their insurance information at the time of service. This ensures that the service provider can, for example, verify that they do in fact accept the individual's insurance for payment of services. The eye care provider can also identify specific coverage information for the individual's insurance policy, which often results in the eye care provider billing the insurer directly to minimize individual out-of-pocket expenses.

When individuals do not carry their insurance policy information, the service provider has the burden of searching for the individual's coverage against the insurance carriers they accept for payment of services. This process is tedious and time consuming and does not guarantee results. This is largely a manual effort that requires an eye care administrator to make a set of calls, with no guarantee of success. Often an administrator lacks the time, patience, incentive, or ability to find individual insurance information, which can result in the patients having to pay in full for the vision related products and services with a possibility of being reimbursed by their vision insurance company at a later time.

### BRIEF SUMMARY

Aspects of the invention assist eye care providers in looking up patient insurance information, thereby automating a process that is conventionally a manual one. Specifically, in the disclosure, a patient not knowing their vision care insurer information can provide information (e.g., demographic information) that they do know. Similarly, eye care providers can provide information regarding a set of insurance plans that they accept. This information can be used to determine a set of possible insurance carriers most likely to provide insurance for the patient that is accepted by the eye care provider. These insurance databases can be automatically searched (one-by-one, in series or in parallel) via a computer connected to a network to determine if a match exists. When a match is determined (regardless of a quantity of insurer specific databases searched), this match can be returned to the eye care provider/patient. Thus, appropriate vision care insurance information is discovered without the manual effort of a human calling a set of specific numbers or performing a manual search against a set of insurer specific sites. This improves an accuracy of a search, permits more comprehensive searching than is typically performed today (i.e., often eye care providers will search one, maybe two, sources for insurance information and then give up, whereas the invention can automatically search a set of insurance databases of arbitrary quantity). Aspects of the disclosure are realized in a number of different embodiments, all of which are to be considered within scope of the inventive arrangements detailed herein.

In one aspect of the disclosure, personal information about an individual seeking eye care products and services from an eye care provider can be received. The personal information may not include vision care identification information. The individual and the eye care provider may be unaware of vision care insurance specifics applicable to a specific situation for which the vision care is being sought. At least one repository of data for vision care information can be searched to identify a set of one or more insurers of the individual accepted by the eye care provider for the specific situation for which vision care is being sought. The repository can be one maintained by an entity independent of the individual and independent of any specific eye care provider. Responsive to the searching, information can be provided from the repository to the eye care provider and/or the individual. The provided information can be sufficient to enable the individual to receive the vision care for the specific situation form the provider, where at least a portion of the vision care is paid for by the set of one or more insurers.

In one embodiment, the personal information can be provided (e.g., manually input) into a single user interface. The personal information can be extracted from this interface at a search device. In one embodiment, the search device can be a Web server that serves the single user interface. The search device can be a computing device that does not maintain the vision care identification information, but that instead searches a set of insurer maintained repositories. The search device can determine a set of likely insurers for the individual from the personal information. A set of insurer maintained data stores corresponding to the set of likely insurers can be ascertained. This set of data stores can be searched and results of the search can be provided to the individual via the single user interface.

In one aspect of the disclosure, demographic information can be manually input into fields of a user interface. The demographic information can be for a patient of an eye care provider. The demographic information can include a set of specific values for the patient including at least patient last name, date of birth and optionally other data points specific to the patient from a set of data points including first name, social security number (complete or last four-digits), zip code, employee number, primary insured last name, primary insured first name, primary insured date of birth, primary insured social security number (complete or last four-digits). One or more likely vision care insurers of the patient can be automatically determined from the demographic information. The likely vision care insurers can be ones that are accepted by the eye care provider. The vision care insurers that are accepted and that the patient is covered under can be unknown initially. A set of insurer maintained data stores corresponding to the set of one or more likely eye care insurers of the patient can be automatically determined. The set of insurer maintained data stores can be automatically searched for insurance information specific to individuals matching the demographic information. Results of the searching can be provided via the user interface, which identifies at least one vision care insurer of the patient and which provides an insurance number specific to an insurance policy of the patient.

### BRIEF DESCRIPTION OF THE SEVERAL VIEWS OF THE DRAWINGS

FIG. 1 shows a diagram for searching for an individual's insurance information in accordance with an embodiment of the inventive arrangements disclosed herein.

FIG. 2 shows a set of graphical user interfaces able to be used in embodiments of the disclosure.

FIG. 3 shows a diagram of a system for searching for an individual's insurance information in accordance with an embodiment of the inventive arrangements disclosed herein.

### DETAILED DESCRIPTION

In one embodiment, a search for vision insurance information can be initiated when a patient attempts to receive eye care products and/or services from a provider. This search can ultimately result in the provider receiving vision insurance information about the person from a set of searched databases (e.g., insurance databases) based on provider and/or patient specific demographic data. The innovation detailed herein is automated and requires little manual effort to discover patient insurance information. In absence of the innovations detailed herein, it is necessary (and standard practice) for a human to manually search multiple different insurance databases and/or call multiple different insurer assistance lines.

More specifically, patient and/or insurance subscriber demographic information can be entered once into a suitable user interface. This demographic information can include, but is not limited to, last name, date of birth, first name, social security number (complete or partial) etc. This information can be automatically checked against a set of insurance databases for insurers that a provider accepts. These databases are not necessarily maintained by the service provider or by a searching entity. Application interfaces can be used to reformat the patient/service provider information, as necessary, to automatically search the insurance databases.

In one embodiment, a search provider can establish a set of insurance plans that the provider accepts. When a request for searching for a patient's insurance information is received (by an entity that performs the insurance search), only the set of insurance company databases matching provider-accepted plans are searched. Similarly, patient-specific demographic information can minimize a set of insurance databases that need to be searched. In one embodiment, the patient/provider demographic information can be used to establish a search order among a set of insurance databases designed to search a most-likely set of insurance databases first. When a match is found, insurance databases less likely to match patient/provider demographic information need not be searched. Results produced by the disclosure can be produced relatively immediately and automatically. Thus, the medical provider (or human agents of the provider) does not need to manually call a set of insurance providers and/or to manually log onto a set of insurance Websites (entering patient/subscriber information for each Web site) looking for a match for the patient. The end result is greater efficiency, quicker results, more comprehensive searching, and a significant savings of manual effort. It should be appreciated (as will be detailed herein) that numerous alternatives and derivatives are contemplated for the disclosure, which have the same or approximately the same overall effect detailed above, and which are to be considered within scope of this disclosure.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

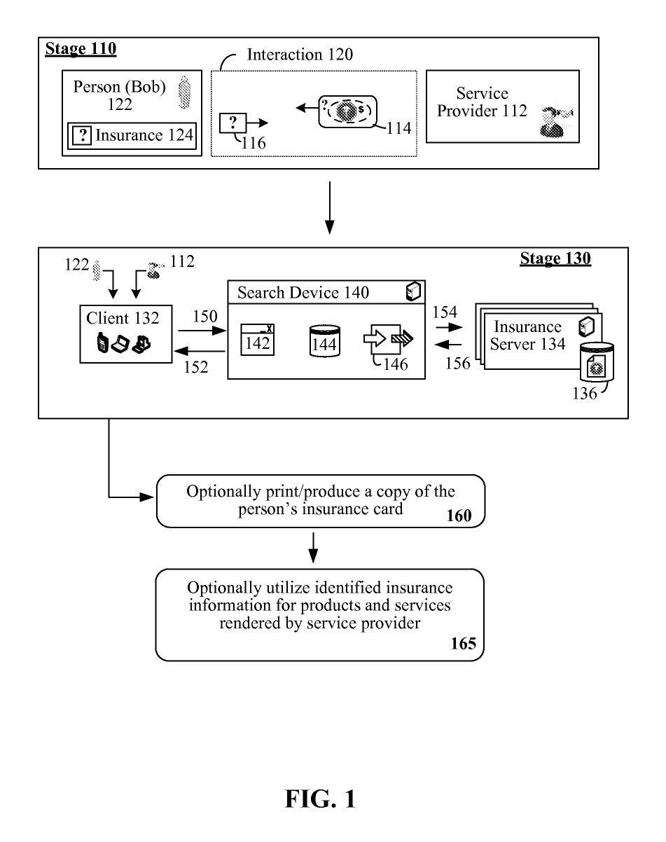

FIG. 1 shows a diagram for searching for an individual's insurance information in accordance with an embodiment of the inventive arrangements disclosed herein. In FIG. 1, an interaction 120 can occur between a person (Bob) 122 and a service provider 112, which is an eye care provider. That is, an eye care provider 112 can request 114 insurance information, which is to be used to pay for vision care products and services. Person (Bob) 122 can have insurance 124 coverage to potentially offset the cost of products and services rendered but may be unaware of the specifics of his insurance 124 coverage. For example, Bob can have forgotten his vision health insurance card, may not know his insurer, and not know coverage specifics. Hence, without the insurance card, Bob may not know some or all of the information medical providers 112 need (in order to properly submit bills to an individual's insurance carrier—or to even determine what liability Bob has regarding vision care products and services). Bob can respond 116 to the request 114 by acknowledging that he is unaware of his insurance 124 specifics.

Thus, stage 110 shows a potential patient 122 attempting to receive medical services, who does not known and is unable to present the specifics (that the service provider 112 requires) regarding insurance coverage. Conventional practices could, at this stage 110, require service provider 112 to manually look up Bob's insurance information by querying multiple insurance companies, could result in the service provider 112 refusing to provide health care to Bob without Bob rendering payment in full (where Bob could possibility be reimbursed by the insurance carrier at a later time for out-of-pocket expenses), and/or could result in Bob frantically trying to gather insurance information before receiving vision care related products and services.

In FIG. 1, however, stage 130 can be initiated where an automated insurance search is conducted. More specifically, a client device 132 can be used by person 122 and/or an agent of service provider 112. Client 132 provides demographic information 150 about person 122 and/or provider 112 to a search device 140, which provides client 132 with results 152.

The demographic information 150 can include information known by/about the person 122, such as a name, date of birth, employer, social security number, and the like. The demographic information 150 only needs to be entered in the client 132 once regardless of the number of insurance servers 134 and databases 136 that are searched.

The results 152 include insurance information (from one or more of the insurance database 136) that is not provided as part of the demographic information 150. For example, an insurance number, a type of coverage, an insurer deductible amount, products covered, procedures covered, maximum coverage amounts, patient-contributions to date (in cases where this is relevant to amounts to be paid by an insurance 124 agency), and other such information. Generally, insurance information included within results 152 can include information that the service provider 112 needs for their records and/or to receive compensation from an insurance 124 agency for eye care products and services. In one embodiment, the results 152 can include insurance data, which the service provider 112 can use to determine an extent of coverage, specific medical procedures covered or not covered by an insurance plan, and the like. In one embodiment, data from the results 152 (not provided within demographic information 150) can help a patient and/or service provider 112 to determine cost-effective treatment options.

The search device 140 can intake the demographic information 150 and determine a subset of insurance servers 134 and insurance databases 136 that are most likely to insure person 122 given the demographic information 150. In one embodiment, the search device 140 itself may not maintain any insurance information specific to a person 122. Instead, this information can be maintained exclusively in a set of insurance databases 136 maintained by a set of insurance servers 134. The search device 140 can construct insurance-company-specific search requests 154 (by leveraging the demographic information 150) for each of the set of insurance servers, which produces insurance-company-specific results 156.

In one embodiment, search device 140 can serve (or support) a user interface 142 through which demographic information 150 can be received and results 152 can be presented. For example, the user interface 142 can represent a Web site served by device 140 to a browser of the client 132. In various embodiments, the user interface 142 can be a graphical user interface (GUI), a voice user interface (VUI), a text user interface (TUI), a multi-modal interface, and the like. In one embodiment, the user interface used for entering information 150 can be a client-side (of client 132) one. It should be emphasized that the user interface 142 (regardless of whether it is provided by device 140 or is a user interface of a client-side application) can include input fields designed to capture values of key demographic fields, which can be used to create values needed for the insurance-company-specific search requests 154.

The search device 140 can include a device-specific data store 144, which is a non-transitory storage medium. In one embodiment, data store 144 can include authentication information (e.g., digital certificates, authentication keys, user account/passcode information, etc.) that permit search device 140 to log into the insurance server(s) 134. In one embodiment, search device 140 can be a device trusted by the insurance server(s) 134 even though the client device(s) 132 may not be trusted by the insurance server(s) 134. In one embodiment, the service provider agent 112 and/or person 122 can provide authentication information for accessing (otherwise secure) insurance data maintained in data store 136. In one embodiment, at least a portion of the data stores 136 can be publically available and therefore not require authentication information.

In one embodiment, the data store 144 can maintain demographic information 150 pertaining to the person 122 and/or the service provider 112. Thus, assuming that a person 122 or service provider 112 interacted with the search device 140 on one or more previous occasions, the provided information can be retained in a persistent data store 144 so it is available for future requests. In one embodiment, stored demographic information retained in data store 144 can auto-populate fields of a user interface 142. That is, once identifying information (a combination of elements that uniquely identify person 122) is entered into the user interface 142 additional stored fields of information can be shown and/or can simply be used to construct the insurance-company-specific search requests 154.

In one embodiment, the search device 140 can include searching functionality for searching public information sources for demographic information about a person 122 and/or provider 112. For example, if a phone number for a person 122 is provided, a reverse directory lookup can be automatically performed by search device 140, which returns additional demographic information about the person 122. Like retained demographic information, discovered information (using a search functionality of device 140) can be used to automatically populate fields of interface 142 and/or to construct the insurance-company-specific search requests 154 for one or more servers 134.

In one embodiment, data store 144 of the search device 140 can retain insurance information from one or more previously conducted searches. That is, it can be assumed that a person 122 who lacks insurance information once when visiting a service provider 112 will need this information in the future. Stored insurance information can be truncated (to save space, for example) in one embodiment to expedite future searches. For example, information against a key field, such as a phone number of the person 122, can be indexed against an insurance number or some other unique key for referencing data store 136 records. Thus, the search device 140 may still need to access insurance information from an insurance server 134 and/or data base 136 to produce results 152, but searches (after the first) can be quickly and accurately performed.

It should be appreciated that any information retained in data store 144 can be sanitized and/or encrypted to retain confidentiality of information. For example, a hash key can be generated from specific demographic information, which is indexed against another key (which can also be a hash key) of one or more insurance servers 134 or data stores 136.

In one embodiment, the search device 140 can include one or more conversion routines 146. These conversion routines 146 can map a format and/or form of demographic information from a form provided (information 150) by a person 122 or agent of a provider 112 into a form needed by a specific insurance server 134 and/or data store 136. That is, different data stores 136 store data in different manners and with different significant characters, which conversion routines 146 can adjust for. Similarly, one or more of the conversion routines 145 can adjust data returned within insurance-company-specific results 156 to a different format, which is presented within results 152.

The insurance servers 134 can represent any set of computing device that maintains a repository of insurance information, such as information retained within data store 136. Although the insurance information is commonly stored by an insurance company itself, other (equivalent) sources can be used herein. For example, company personnel systems can retain insurance information for their employees, which can be accessed as an alternative source to the insurance company maintained data store. It can be advantageous to utilize an insurance company's data store 136, as this is a source that should contain the most accurate and up-to-date information.

In one embodiment, the results of stage 130 can be used to directly provide information to client 132. When the client 132 is a computer of the service provider 112, records of the service provider can be automatically updated with data from the results, which minimizes problems with manual transcription errors. In one embodiment, the information from the result 142 can be presented to a human user, who must then manually enter this information within patient database (or application) of the service provider 112. In still another embodiment, the results can be provided to a device of a patient, such as a mobile phone, which can be shown to an agent of the service provider 112 and/or used by a patient (person 122) to fill out a form/questionnaire provided by the service provider 112.

A couple of actions 160 and 165 are explicitly shown that express how the results 152 may be used. These actions 160, 165 are non-comprehensive and others are contemplated. Action 160 permits a copy of the person's insurance card to be printed, so that the person 122 can have a copy of it for when it is next needed. Also, some service providers 112 can retain an image of an insurance card for their records, where this image can optionally be conveyed within result 152. Action 165 shows that the identified insurance information can be optionally utilized to pay for products and services rendered by service provider 112.

In one embodiment (not shown) the search device 140 can send different result 152 information to a client 132 of the person 122 and to a client 132 of the provider 112. For example, a set of medical care procedures can be performed by a set of multiple service providers 112 (within a practice group), where a patient 122 can be provided (within one response 152) a summary including what his/her contribution should be for the procedures, while individual service providers 112 are provided (within different tailored responses 152) with information specific to a procedure that they perform only. This same situation can exist when a patient 122 has multiple different insurance plans (possibly with different insurance 124 agencies), where a set of one-or-more medical procedures performed are covered by more than one insurance plans. In such a situation, summaries of costs/coverage (from the set of insurance 124 agencies) can be provided in tailored messages (responses 152) sent to one or more clients 132.

As used herein, a service provider 112 can be any entity providing eye care related products and services. At least a portion of these services can be covered by a vision insurance 124 policy. For example, service provider 112 can represent a physician, an optometrist, an optician, an ophthalmologist, and the like.

A computing device (such as client 132, server 134, and/or search device 140) can be a machine comprising hardware, software, and firmware. The hardware can include at least one processor, at least one memory (volatile or non-volatile), a network interface card (NIC), input/output peripherals for user interaction, and the like. The software can include an operating system, and one or more applications executing on the operating system, and user interface(s) for machine-to-human interactions, application program interface(s) for machine-to-machine interactions, and the like.

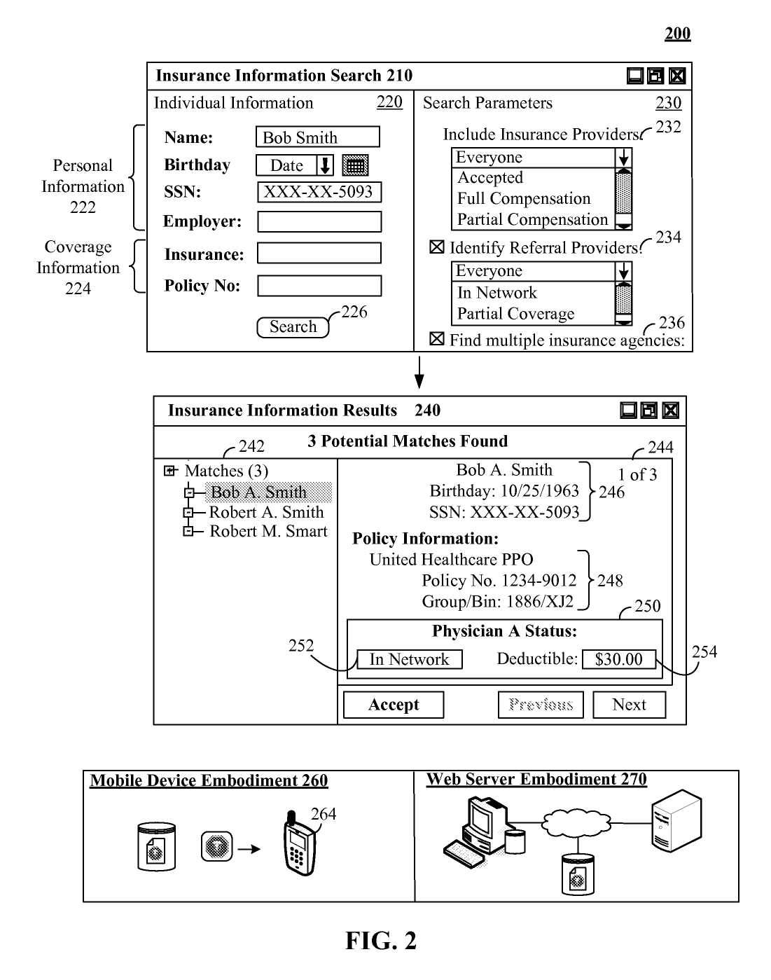

FIG. 2 shows a set of graphical user interfaces 210, 240 able to be used in embodiments of the disclosure. For example, the graphical user interface 142 can include specifics shown in user interfaces 210, 240 in one embodiment. The user interfaces are not intended to be comprehensive and other types, alternatives, and arrangements for machine-to-human interfacing are contemplated and are to be considered within scope of the disclosure.

User interface 210 shows an interface for inputting personal information 222 (e.g., demographic information about a person), such as name, birthdate, social security number, phone number, address, employer, sex, etc. In one embodiment, an “auto-populate” feature can be implemented, where input fields not entered by a person can be filled automatically.

Coverage information 224 is also shown for the user interface. It is to be expected, in one embodiment, that a user is unable to provide proper information in these fields, which is why a set of insurance databases (e.g., data stores 136) need to be searched based on the demographic (information 222) data. A user of interface 210 may know partial information about their coverage, however, which can be input into coverage information 224 fields and used to help in finding additional information. For example, an insurance company name can be filled into one of the interface fields, which the search device (e.g., device 140) can used to target specific insurance agency likely to have proper coverage information. In another embodiment, a common interface (e.g., user interface 210) can be used for patients who know their insurance information (which may be optionally verified in the process) and for patients who do not know their insurance information.

In one embodiment, a set of search parameters 230 can be configured by a user of interface 210. These search parameters 230 can be used to minimize a depth and breadth of a search for insurance providers. For example, in one embodiment, providers 232 can be limited to those accepted by a medical service provider (e.g., within a network of a service provider 132) or to search for insurance providers not specifically affiliated with a service provider. For example, many insurance agencies provide some coverage for “out of network” medical care providers, which can be at less favorable terms (e.g., a patient must pay more) than available for preferred health care providers within a network. A search for providers 232 can be limited to coverage thresholds (full, partial, etc.) as well. Another configurable search parameter 230 can be an option to include/exclude referral providers 234 within a search. An option 236 can exist to search for multiple insurance providers or not. For example, after a match is found with one insurance provider, should the search stop or continue in case a patient's medical care may be covered under more than one insurance plan.

Once a search 226 function is activated, multiple insurance agency databases (e.g., data stores 136) can be searched based on the input information. These searches are fully automated (requiring no additional prompting/information from a user) or semi-automated. A semi-automated process may situationally prompt a user for needed information, such as an access code for a specific insurance provider needed to receive access to insurance data. A semi-automated process can also require a person to verify whether a “potential match” is in fact related to a patient or not. That is, the search can be biased so that some false positives are possible (or even anticipated) to ensure that true positives have a high likelihood of being identified and presented to a user.

Turning to screen 240 (which can be a screen of the application associated with user interface 210), a set of one or more possible matches can be presented. For example, a side pane 242 with a list of matches retrieved can be presented along with a detail pane 244. Detail pane 244 can display items such as personal information 246 and coverage information 248 for the potential match selected from side pane 242. The personal information 246 can match (or approximately match) provided demographic information (from fields 222). The policy information 248 can include insurance information acquired from one or more insurance databases, which was not known before the search. In one embodiment, items from details pane 244 can be partially obscured until proper authentication can be guaranteed in order to preserve privacy and confidentiality.

Additionally, detail pane 244 can include a service provider status 250 window in the event that a service provider has been identified as the searching entity or a target service provider. The service provider status 250 window can include items such as compensation level 252 (for example, whether the physician is in network or out of network, etc.) as well as any potentially applicable deductible 254 to be paid by the insurance holder (Bob).

As previously mentioned, the results shown in a user interface 240 can be performed in various manners. Embodiments 260 and 270 emphasize that a client (e.g., client 132) device upon which the user interfaces (e.g., interface 210 and 240) are presented can vary from embodiment to embodiment. For example, in a mobile device embodiment 260, an interactive device 264 can be a provider's or patient's smart phone, tablet, netbook, personal computer, and the like. Thus, the interfaces (210, 240) can be used by a patient to look-up insurance information in one embodiment. In such an embodiment, no infrastructure changes are required of an information technology (IT) infrastructure of a service provider (e.g., provider 112).

Alternatively, the device 264 can be a portable one provided by a service provider, which is designed for a patient to utilize. For example, a patient can be provided with a touch-pad (e.g., IPAD, ANDROID TABLET, etc.), which is used in lieu of a paper patient in-take form.

Another contemplated embodiment (shown as Web server embodiment 270), the user interface 210, 240 can be provided on a computer connected to a network. For example, a client having a browser can access an insurance search Web site hosted by a search device (e.g., device 140). The client can be one used by a patient (e.g., person 122) an agent of a service provider (e.g., provider 112) or both. Other embodiments are contemplated (such as use of a plug-in integrated to a provider's patient management system) and are to be considered within scope of the disclosure.

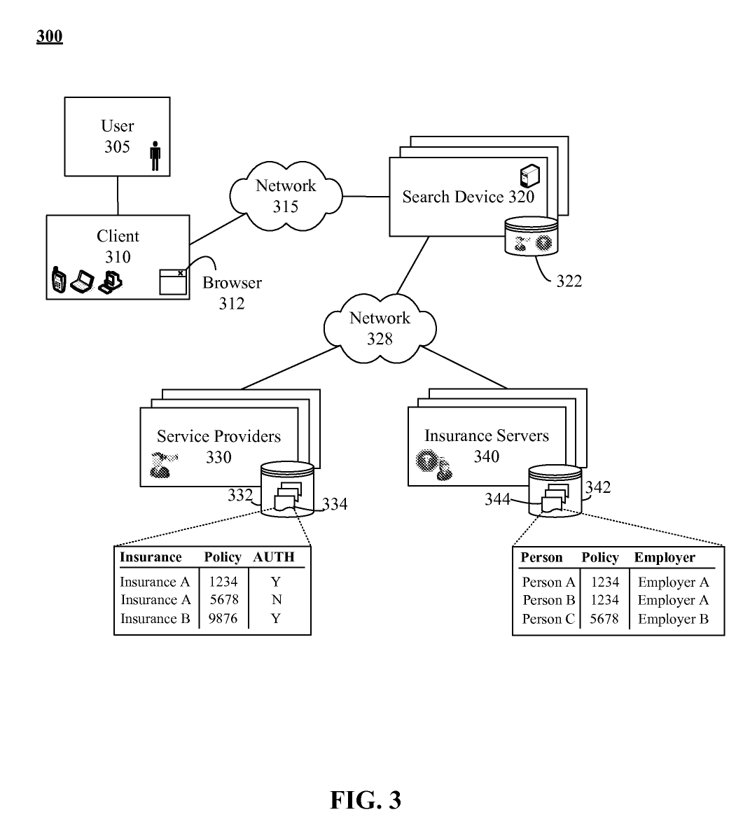

FIG. 3 shows a diagram of a system 300 for searching for an individual's insurance information in accordance with an embodiment of the inventive arrangements disclosed herein. The system 300 represents an illustrative system for implementing the arrangements of FIGS. 1 and 2. System 300 is not to be construed as limiting, and other arrangements and derivatives are contemplated.

FIG. 3 shows a user 305 accessing a client 310, which may include browser 312. Client 310 can interface over network 315 with insurance search device 320, which is connected to data store 322. The data store 322 itself can lack insurance information necessary for eye care service providers 330 providing products and services to user 305. This information can reside in a set of data stores 342 maintained by a set of insurance servers 340.

In one embodiment, data store 322 can include data useful for identifying a set of relevant insurance data stores 342 likely to include records for a user 305. This information can include records that map user 305 demographic information 324 and service provider information to likely insurance servers 340 and/or data stores 342. The search device can be communicatively linked to a set of service providers 330 and insurance servers 340 through network 328.

Service provider 330 can maintain information regarding services provided to patients in data store 332. At least a portion of this information can be confidential and/or protected by legal privileges specific to medical records. The data store 332 can also store billing information for these medical services and products. This billing information can detail portions of a bill that a patient pays, portions of a bill that an insurance agency is to pay (along with policy information and authorization indicators if necessary), as shown by record 334. In one embodiment, the data store 332 can include information regarding a set of insurance companies (and their contact and access information) that the service provider 330 accepts.

Insurance servers 340 can maintain policy information 344 within data store 342. Policy information 344 can include insurance information for individuals, their respective insurance plans, their employer or relative through whom the individuals are insured, and the like. Other records for service information and policy information augmenting the previously described options are contemplated.

Network 315 and/or 328 can include any hardware/software/and firmware necessary to convey data encoded within carrier waves. Data can be contained within analog or digital signals and conveyed though data or voice channels. Network 315, 328 can include local components and data pathways necessary for communications to be exchanged among computing device components and between integrated device components and peripheral devices. Network 315, 328 can also include network equipment, such as routers, data lines, hubs, and intermediary servers which together form a data network, such as the Internet. Network 315, 328 can also include circuit-based communication components and mobile communication components, such as telephony switches, modems, cellular communication towers, and the like. Network 315, 328 can include line based and/or wireless communication pathways. It should be noted that while networks 315 and 328 are illustrated as two separate networks other network configurations are contemplated. For example, in one embodiment, network 315 and network 328 may be one and the same network.

Data store 322, 332, 342 can represent data stores able to be physically implemented within any type of hardware including, but not limited to, a magnetic disk, an optical disk, a semiconductor memory, a digitally encoded plastic memory, a holographic memory, or any other recording medium. Data stores 322, 332, 342 can be a stand-alone storage unit as well as a storage unit formed from a plurality of physical devices. Additionally, information can be stored within data stores 322, 332, 342 in a variety of manners. For example, information can be stored within a database structure or can be stored within one or more files of a file storage system, where each file may or may not be indexed for information searching purposes. Further, data stores 322, 332, 342 can utilize one or more encryption mechanisms to protect stored information from unauthorized access.

The diagrams in the FIGS. 1-3 illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for facilitating eye care interactions comprising:
receiving personal information about an individual seeking eye care products and services from an eye care provider, wherein the personal information does not include eye care identification information, wherein neither the individual nor the eye care provider are aware of vision care insurance specifics applicable to a specific situation for which the eye care is being sought;
searching at least one repository of data for eye care information to identify a set of one or more insurers of the individual accepted by the eye care provider for the specific situation for which eye care is being sought, wherein the repository is one maintained by an entity independent of the individual and independent of any specific eye care provider; and
responsive to the searching, providing information from the repository to at least one of the eye care provider and the individual, wherein the provided information is sufficient to enable the individual to receive the eye care for the specific situation from the provider, wherein at least a portion of the eye care is paid for by the set of one or more insurers of the individual.

2. The method of claim 1, further comprising:
providing the personal information within a single user interface;
extracting the personal information at a search device, which doesn't maintain the eye care identification information;
determining from the personal information a set of likely insurers for the individual; and
ascertaining a set of insurer maintained data stores corresponding to the set of likely insurers, wherein the at least one repository comprises the set of insurer maintained data stores.

3. The method of claim 2, wherein the individual using the single user interface remains unaware of which specific insurer maintained data stores are searched.

4. The method of claim 2, further comprising:
constructing from the personal information a plurality of insurer-specific-search requests, each of which requires a conversation of the personal information to a format specific to a corresponding insurer maintained data store;
submitting the insurer-specific-search requests from the search device to the insurer maintained data stores and receiving a plurality of insurer-specific results in return; and
creating a single response from the data contained in the plurality of insurer-specific results, wherein the providing of information provides the single response.

5. The method of claim 1, wherein the provided information is provided to the individual via an application running on a smartphone or a personal internet device of the individual.

6. The method of claim 1, wherein the provided information is provided to the eye care providers as part of a Web service to which the health care provider subscribes, said method further comprising federating information of a plurality of different vision insurance companies to create the repository.

7. The method of claim 1, wherein the set of at least one insurers comprises a plurality of insurers, wherein each of the plurality of insurers provide a level of coverage to the individual for the eye care as provided by the eye care provider, wherein the providing ensure maximum benefits are provided to the individual by the set of eye care providers, where the maximum benefits minimizes costs for the eye care paid by the individual while maximizing a breath of procedures performed by the eye care provider.

8. The method of claim 1, further comprising:
manually inputting into fields of a user interface demographic information for a patient of an eye care provider, wherein the demographic information comprises a set of specific values for the patient including at least patient last name and date of birth from a set of data points including first name, complete social security number, partial social security number, zip code, employee number, primary insured last name, primary insured first name, primary insured date of birth, primary complete insured social security number, primary partial social security number, or combinations thereof, wherein said personal information comprises the manually input demographic information;
automatically determining from the demographic information a set of one or more likely eye care insurers of the patient, which are accepted by the eye care provider, wherein the eye care insurers are initially not known; and
automatically determining a set of insurer maintained data stores corresponding to the set of one or more likely eye care insurers of the patient
wherein said at least one repository of the searching step comprise the set of insurer maintained data stores, wherein said searching further comprises automatically searching the set of insurer maintained data stores for insurance information specific to individuals matching the demographic information, and
wherein said providing information further comprises providing results of the searching via the user interface, which identifies at least one eye care insurer of the patient and provides a vision insurance number specific to an insurance policy of the patient.

9. The method of claim 1, further comprising:
linking the repository to a plurality of personnel systems of companies, wherein details of eye care coverage for specific individuals, which include the individual, are maintained within the personnel system;
software of the entity validating access to the personnel system responsive to receiving the personnel information, wherein the personnel information includes an authorization code for accessing the personnel system; and
providing information for at least one of the set of insurers only after and contingent upon access to the personnel system being successfully validated, wherein computing system of the eye care provider lack direct access to information maintained in the personnel system relating to the individuals.

10. The method of claim 1, further comprising:
during the searching, determining from the personal information a company that employs the individual;
looking up records of the repository that indicate a set of insurers of the company; and
searching specific records of only the set of insurers of the company to determine the set of one or more insurers of the individual.

11. A method for searching for insurance information comprising:
manually inputting into fields of a user interface demographic information for a patient of a eye care provider, wherein the demographic information comprises a set of specific values for the patient including at least patient last name and date of birth from a set of data points including first name, complete social security number, partial social security number, zip code, employee number, primary insured last name, primary insured first name, primary insured date of birth, primary complete insured social security number, primary partial social security number, or combinations thereof ;
automatically determining from the demographic information a set of one or more likely eye care insurers of the patient, which are accepted by the eye care provider, wherein the eye care insurers are initially not known;
automatically determining a set of insurer maintained data stores corresponding to the set of one or more likely eye care insurers of the patient;
automatically searching the set of insurer maintained data stores for insurance information specific to individuals matching the demographic information; and
providing results of the searching via the user interface, which identifies at least one eye care insurer of the patient and provides a vision insurance number specific to an insurance policy of the patient.

12. The method of claim 11, wherein the provided results are sufficient to enable the patient to receive the eye care from the eye care provider, wherein at least a portion of eye care provided by the health care provided is to be paid for by the identified eye care insurer.

13. The method of claim 11, wherein the automatically determining of the likely eye care insurers, the automatically determining of the set of insurers, the searching the set of insurer maintained data stores, and the providing of results occurs automatically by a computing device without requiring human agents to directly interact with any of the set of insurers and without requiring human agents to manually search individual ones of the insurer maintained data stores.

14. The method of claim 11, wherein the searching entity that provides computing hardware and software for performing the search and producing the results from the demographic information is unaffiliated with the service provider or the insurance provider.

15. The method of claim 14, wherein said searching entity is remunerated for services rendered by at least one of the insurer, the patient, and the eye care provider.

16. A computer program product comprising a computer readable storage medium having computer usable program code embodied therewith, the computer usable program code comprising:
computer usable program code stored in a storage medium, if said computer usable program code is executed by a processor it is operable to receive personal information about an individual seeking eye care from an eye care provider, wherein the personal information does not include eye care identification information, wherein neither the individual nor the eye care provider are aware of eye care insurance specifics applicable to a specific situation for which the eye care is being sought;
computer usable program code stored in a storage medium, if said computer usable program code is executed by a processor it is operable to search at least one repository of data for eye care information to identify a set of one or more insurers of the individual accepted by the eye care provider for the specific situation for which eye care is being sought, wherein the repository is one maintained by an entity independent of the individual and independent of any specific eye care provider; and
computer usable program code stored in a storage medium, if said computer usable program code is executed by a processor it is operable to, responsive to the searching, provide information from the repository to at least one of the eye care provider and the individual, wherein the provided information is sufficient to enable the individual to receive the eye care for the specific situation from the provider, wherein at least a portion of the eye care is paid for by the set of one or more insurers of the individual.

17. The computer program product of claim 16, wherein the provided information is provided to the individual via an application running on a smartphone or a personal internet device of the individual.

18. The computer program product of claim 16, wherein the provided information is provided to the eye care providers as part of a Web service to which the eye care provider subscribes.

19. The computer program product of claim 16, wherein the set of at least one insurers comprises a plurality of insurers, wherein each of the plurality of insurers provide a level of coverage to the individual for the eye care as provided by the eye care provider, wherein the providing ensure maximum benefits are provided to the individual by the set of eye care providers, where the maximum benefits minimizes costs for the eye care paid by the individual while maximizing a breath of procedures performed and products offered by the eye care provider.

20. The computer program product of claim 16, further comprising:
computer usable program code stored in a storage medium, if said computer usable program code is executed by a processor it is operable to link the repository to a plurality of personnel systems of companies, wherein details of eye care coverage for specific individuals, which include the individual, are maintained within the personnel system;
computer usable program code stored in a storage medium, if said computer usable program code is executed by a processor it is operable to validate access to the personnel system responsive to receiving the personnel information, wherein the personnel information includes an authorization code for accessing the personnel system; and
computer usable program code stored in a storage medium, if said computer usable program code is executed by a processor it is operable to provide information for at least one of the set of insurers only after and contingent upon access to the personnel system being successfully validated, wherein computing system of the eye care provider lack direct access to information maintained in the personnel system relating to the individuals.
